(19) United States
(12) Patent Application Publication
(10) Pub. No.: US 2005/0023344 A1
(43) Pub. Date: Feb. 3, 2005

(54) Method for registration of tickets using slot zones and container telegrams

(75) Inventors: August Kaelin, Bonstetten (CH); Balz Schreier, Zurich (CH); Bruno Wenger, Au (CH)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS TRANSIT TELEMATIC SYSTEMS AG, NEUHAUSEN (CH)

(21) Appl. No.: 10/883,687

(22) Filed: Sep. 28, 2004

Related U.S. Application Data
(63) Continuation of application No. PCT/EP02/11663, filed on Oct. 18, 2002.

(30) Foreign Application Priority Data
Jan. 14, 2002 (EP) 02 000 760.6

(51) Int. Cl. G06K 5/00

(52) U.S. Cl. 235/382

(57) ABSTRACT

In an entrance zone, or a prompting zone, a second transmitting receiving module located on the ticketed is activated. A communication can thus be established between the ticket and a second transmitting receiving unit which is assigned to a detection zone. During this communication, the presence of the ticket is determined and registered in a defined time slot pattern. This guarantees a reliable and fraud proof detection of tickets. The method and system for registering tickets is used in public transport, at exhibitions and in secured areas.

### CROSS REFERENCE TO RELATED APPLICATIONS

The present application is a continuation of international application PCT/EP00/08292, filed Aug. 25, 2000, which designated the United States and further claims priority to Swiss patent applications: 1665/99 and 2352/99, filed Sep. 10, 1999 and Dec. 22, 1999 respectively. The above applications are herein incorporated by reference.

### BACKGROUND OF THE INVENTION

The present invention relates to the area known as fare management with electronic tickets. The registration procedures are referred to a Walk-in/Walk-out or also Be-in/Be-out. Publication WO 01/03057 Al discloses a Walk-in/Walk-out procedure in a which the direction of movement of an electronic ticket is established directly or indirectly in an area around the door of a vehicle on the basis of what is known as a history. With the procedure described in publication WO 01/20557 A1 a service obtained is billed on the basis of a registration which determines whether an electronic ticket was located within a registration zone at defined points in time. With this method and the corresponding system the tickets are transferred by a first transmitter into an awake state so that subsequently while the service is being obtained, e.g. during a journey, registration can be performed by means of bidirectional intermittent communication. The energy requirements on the tickets dictate that communication is intermittent in the sense that the receiver modules located on the tickets are only switched to active at specific points in time within a frame in a ready-to-receive mode. This bidirectional communication is undertaken in a zone which has the width of a tram for example. In this case volumes of around 100 to 150 different tickets can be reliably registered between two stops. In order to avoid collisions or, if a collision does occur in communication, to still be able to reliably register all tickets where possible, WO 01/84472 proposes a method of collision management in which a check is made before a message is issued as to whether the radio medium is free. Collisions occurring despite this are detected by a missing acknowledgement message. Thereafter the transmission of a message is repeated at a fixed interval or at an interval determined by a random generator, in which case ongoing checks are made in this further phase to ensure that the radio medium is free.

The method disclosed in WO 01/20557 A1 is very demanding as far as timing is concerned in order for the tickets to be ready to receive within the agreed time frame. The proposed methods from the prior art mentioned no longer entirely fulfill the requirements of further applications, for example providing enhanced information about the person carrying the ticket. The method disclosed in WO 01/20557 A1 is also known as the be-In/be-out method and stands for the attribute whereby the actual presence is registered.

### SUMMARY OF THE INVENTION

An object of the present invention is thus to specify a method of the type mentioned at the start which allows a simplification in bidirectional communication and still allows high flexibility and expansion for further applications, especially a broadcast-type or explicitly-addressed distribution of information. The procedural steps in accordance with the invention, by which,
marq: the first information unit contains the identity of the registration zone or the transmitter and transceiver units assigned to the registration zones and when received by a ticket is stored on the latter;
phase: with a further first information unit received by a ticket bidirectional communication is then initiated by means of second information units, if the identity transferred in the marq: and phase: procedural steps matches, with a field (KEY) being provided in the second information unit which describes the structure of the second information unit;
a method is created with which bidirectional communication is always initiated with a first information unit and thereby no expensive timing has to be maintained for a large number of tickets. This significantly reduces the number of collisions and by specifying the structure of the second information unit transferred information can be transferred in a very flexible manner and thus distributed. Such a procedure—also referred to as semi-duplex, also allows specific information to be distributed using addressing or broadcasting in order to be able to implement services known as Public Broadcast Messaging.

This produces the following additional advantages:
i) The fact that the frequency of the first transmitter units is selected so that the field within the registration zone is embodied as a near field;
means that the tickets can be woken with the first information unit and thus have a lower energy requirement.
ii) The fact that the procedural step phase: is subdivided into the steps phase1: and phase2: means that in the first step presence can be established from the tickets by means of bidirectional communication and information can be explicitly transferred to the tickets in the second step.
iii) The fact that in procedural step phase1: a first frame with a fixed subdivision into slots and a second frame are provided and that an assignment to a slot with a slot number can be stored on each ticket; means that communication with a plurality of tickets within a registration zone can be maintained without collisions occurring in communication because of the number of tickets.
iv) The fact that each ticket on which a slot number is stored, transmits a second information unit in the slot concerned and the other tickets transmit a second information unit at a random specific time within the second frame, with a slot number being specified in the acknowledgement message and stored if assignment has not yet been completed or not recognized as valid; enables all new tickets which come into a registration zone to be provided with a slot number and thus allows secure registration even with a large turnover of bearers of tickets.
v) The fact that the tickets are switched to active during sending out of a second information unit and an interval after it; means that acknowledgement messages can be received by the tickets involved without this resulting in a longer switch-on time and a correspondingly higher energy.
vi) The fact that the procedural step phase2: is undertaken in a frame with a fixed division into slots and after receipt of the further first information unit each ticket is switched to active in the slot concerned in order to be able to receive a second information unit sent out by the second transceiver; means that collisions as a result of the plurality of tickets are excluded in bidirectional communication and information can also be explicitly transmitted in the direction of the tickets.
vii) The fact that an acknowledgment message is sent out when a check in the data link layer established that there was no error; means that no further check need be made at the application level and by just a partial activation of the ticket circuit energy consumption can also be restricted.
iix) The fact that in the first and/or second information units transferred to the ticket information is contained in at least one information field indicating that the information unit involved is directed to only one ticket or to a plurality of tickets; means that the same information unit only need only be transferred once by providing a single specific slot for such a broadcast message.
ix) The fact that the first and/or second information units transferred to the tickets contain a continuous number in at least one information field which then undergoes a change if the payload content of an information unit previously sent out has undergone a change; means that if the tickets involved establish equivalence to a previously transferred continuous number a second information unit received can be discarded early on and the ticket circuit transferred to the switching state again if necessary; this also makes it possible for the energy requirement to be reduced.

### BRIEF DESCRIPTION OF THE SEVERAL VIEWS OF THE DRAWINGS

The invention will be explained in more detail below on the basis of a the drawing used to show the registration of tickets in a railway carriage. The diagrams show:

FIG. 1 the floor plan of a railway carriage with entrance and corridor areas and the arrangement of transceiver units and the associated zones;

FIG. 2 Layout of an electronic ticket;

FIG. 3a Sequence of communication with a ticket in the overview with the procedural steps marq, phase1 and phase2;

FIG. 3b Illustration of communication with a ticket using various information units;

FIG. 4 Detailed illustration of communication with a plurality of tickets by means of slot zones in the phase1 procedural step; and

FIG. 5 Detailed illustration of communication with a plurality of tickets by means of slot zones in the phase2 procedural step.

### DETAILED DESCRIPTION OF THE INVENTION

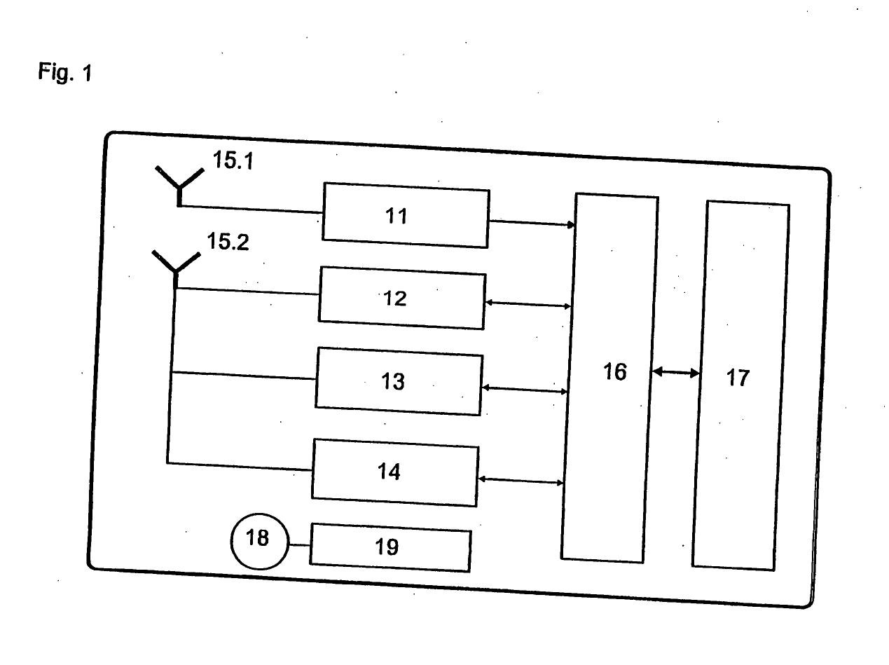

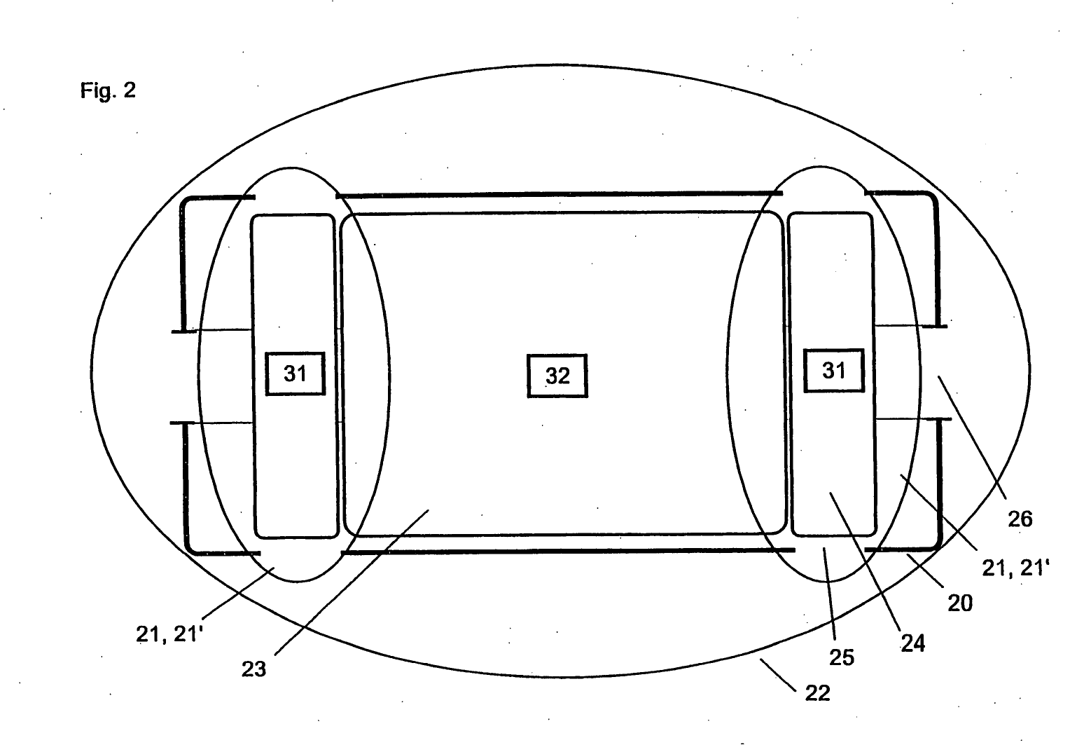

FIG. 1 shows the floor plan of a railway carriage 20 with four entry zones 25 and a corridor area 26 at the end of the carriage. The two areas 25, 26 allow access via a platform 24 to a passenger compartment 23. To aid clarity the doors of the carriage are not shown in the drawing. A first transmitter unit 31 and a second transceiver unit 32 is assigned to each of the two platforms 24. The spatial arrangement of the above-mentioned units 31 and 32 is merely shown by way of an example in FIG. 1. Further transmitter units 31 can also be provided inside the carriage, depending on the length of the carriage, a transmitter unit 31 covers a specific environment with an electromagnetic field embodied as a near field. The near field is usually defined by r<0.6 λ), with λ standing for the wavelength For an range of 1 m to appr. 6 m in the registration zone 22 a frequency of 30 MHz is produced. In practice frequencies of 27 MHz, 13.5 MHz and of 6.78 MHz have proved especially advantageous. However, as mentioned above, a number of transmitter units 31 are to be provided if need be for the distance of 1 m. 6 m. As far as the second transceiver unit 32 is concerned the restriction of the registration zone 22 roughly corresponds to the range within which reception by a second transceiver module 12 on ticket 10 is still secure. The electromagnetic field sent out by transceiver unit 32 should where possible exhibit a sufficient field strength and good propagation characteristics everywhere in the carriage. A frequency band in the range 433 MHz or 868 MHz is typically provided for this. Above a frequency of around 300 MHz the electromagnetic field in the registration zone 22 considered is embodied as a far field. Two frequencies can be provided from the 433 MHz or 868 MHz bands previously mentioned, differing by 200 or 500 KHz for example, for the downlink and uplink. Overlapping of the two registration zones 22 corresponding to the paired arrangement of the transceiver units 32 for this railway carriage 20 is advantageous in order to be able to register all passengers regardless of their position in railway carriage 20.

FIG. 2 shows the block diagram of an electronic ticket 10. Such tickets 10 preferably have a credit card format. As regards their technology, such portable cards are known to experts as “Smartcards”. In the block diagram a processor module 16 is provided as a central control unit with an assigned memory module 17 and also linked to a receiver module 11, a second 12, a third 13 and a fourth transceiver module 14. The third and fourth receiver module can be provided for what are known as proximity or vicinity applications. Depending on the frequencies selected, just one or a number of antennas can be provided, in the embodiment shown in FIG. 1 two antennas 15.1 and 15.2 are provided. Energy is supplied by means of a battery 19 and a power supply module 18.

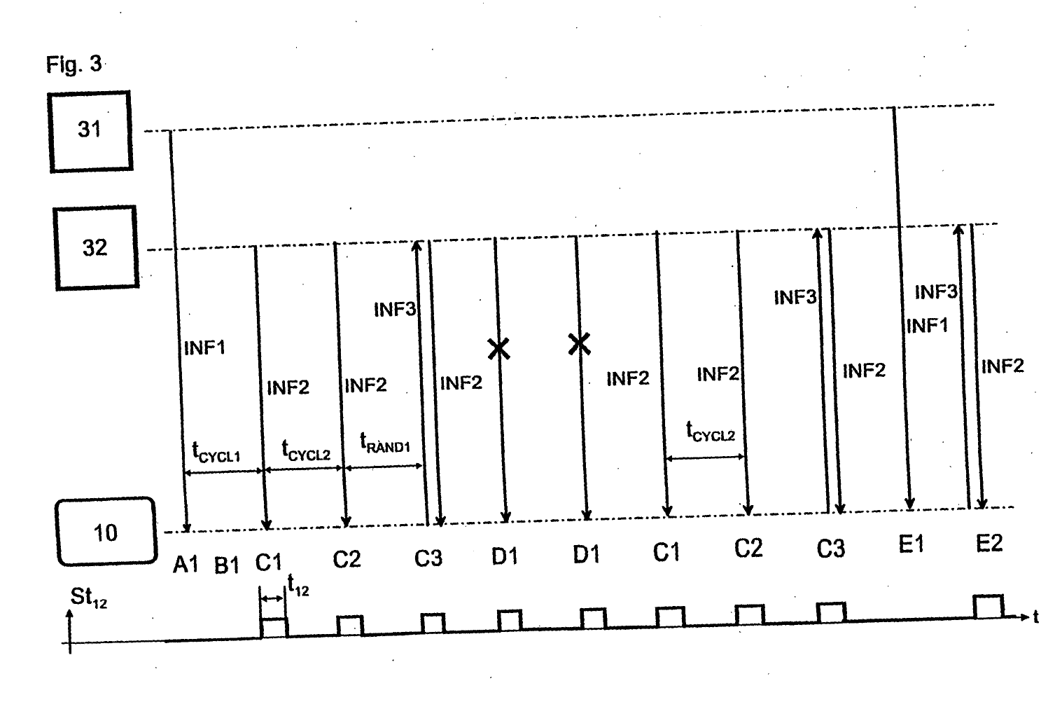

The basic sequence of bidirectional communication is illustrated in FIG. 3a. The sequence of the method in accordance with the invention will be explained using the example of a journey by tram between two stops Loc A and Loc B. The direction from Loc A to Loc B includes both a change of location and also the passage of a specific period of time, lasting between 20 s to around 120 s. Phases marq and phase are provided for registration of the tickets between stops Loc A and Loc B in accordance with FIG. 3a. In this embodiment the phase phase is subdivided into the phases phase1 and phase2, in which case the phase phase can be iterated. FIG. 3b shows the information units T, U and Q transferred in the individual phases, these information units also being referred to by experts as telegrams. Common to the phases phase or phase1 and phase2 is the fact that bidirectional communication between the second transceiver unit 32 and tickets 10 is always initiated by a first information unit S or S_{G} and S_{T} originating from a first transmitter unit 31.

A preferred embodiment of the method in accordance with the invention includes the steps listed below. The content and the structure of the first and second information units transferred is explained further on in this document:

Overview of Procedural Step Marq:

At stop Loc A in phase marq ticket 10 is stamped with the first information unit St_{A}. Tickets 10 located in the registration zone 22 are “woken” from an energy-saving sleep state by receipt of this first information unit. The way in which “waking” operates is explained below. The abbreviation “marq” used here stands for marquage (French) and in a figurative sense means stamping. The information unit St_{A} is sent out by means of the first transmitter unit 31. In this case the identity of the first transmitter unit 31 or of the vehicle 20 or registration zone involved is contained in the first information unit St. On condition that the first information unit ST has been correctly received—this identity is stored on ticket 10. A stack is preferably provided to organize the storage of the received identities, depending on the application it can also be organized in the form of ring storage or even FIFO (First-In, First-Out) storage. Advantageously in the marq phase the first information unit ST is sent out a number of times between the time marks identified by arr and dep. In the present exemplary embodiment arr and dep stand for the arrival or departure of a tram at a tram stop.

Overview of Procedural Step Phase1:

After the tram involved has departed a further first information unit S_{Q} is sent out by the first transmitter unit 31. As already mentioned, the electromagnetic field of the first transmitter unit 31 is embodied as a near field, i.e. tickets 10 located in this area are “woken” from a sleep state by field strength H. One item of information transferred by the first information unit S_{G} is the identity of the first transmitter unit 31 or the first vehicle or registration zone involved and another is a request to the ticket receiving this unit S_{G} to send out a second information unit T. This unit is not sent if the identity contained in the first information unit S_{G} has not been stored beforehand on the ticket involved in a procedural step marq:. Under the given conditions a ticket 10, after receiving the first information unit S_{G} then transmits a second information unit T to the second transceiver unit 32, at which point this unit acknowledges receipt to ticket 10 with a further second information unit Q. The acknowledgement with the second information unit Q includes the correct receipt of an information unit T, which for example is established by a CRC (CRC=Cyclic Redundancy Check) and obviates the need for checking in higher layers. In expert terms this means that errors are detected in the data link layer.

Overview of Procedural Step Phase2:

Provision can be made in this procedural step for new information units U to be transferred to the tickets 10. To this end the first transmitter unit 31 sends out a first information unit S_{S} which announces the sending out of a subsequent second information unit U to be transferred by the second transceiver unit 32. The ticket 10 receiving the second information unit U acknowledges the receipt with a further second information unit Q. As already previously explained, the acknowledgement takes the form of a CRC check and is only transmitted if no error was detected.

If necessary and until stop Loc B is reached, the steps phase1 and phase2 can be iterated.

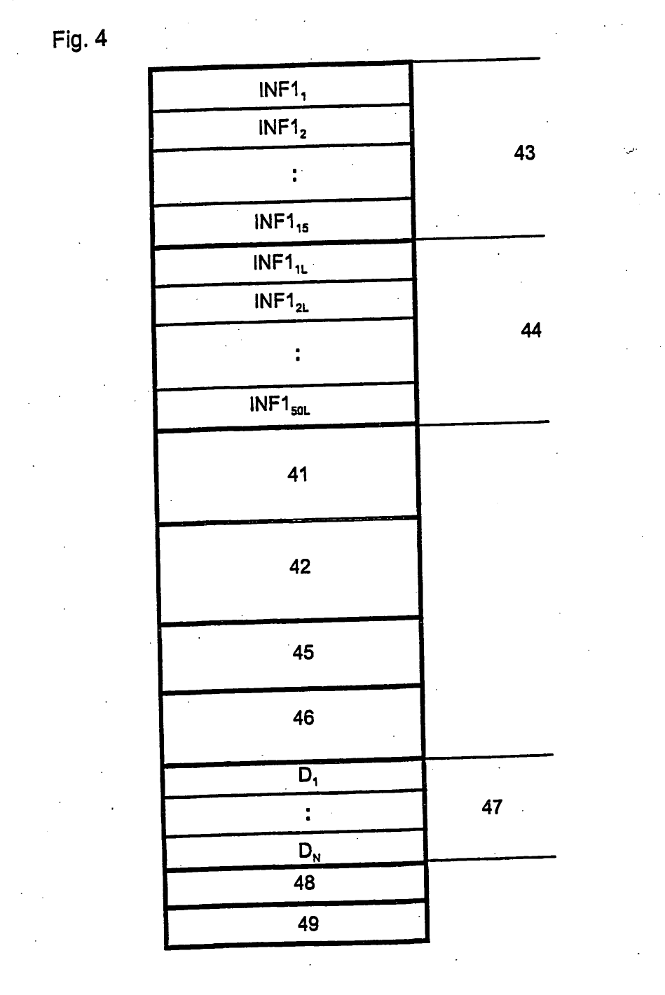

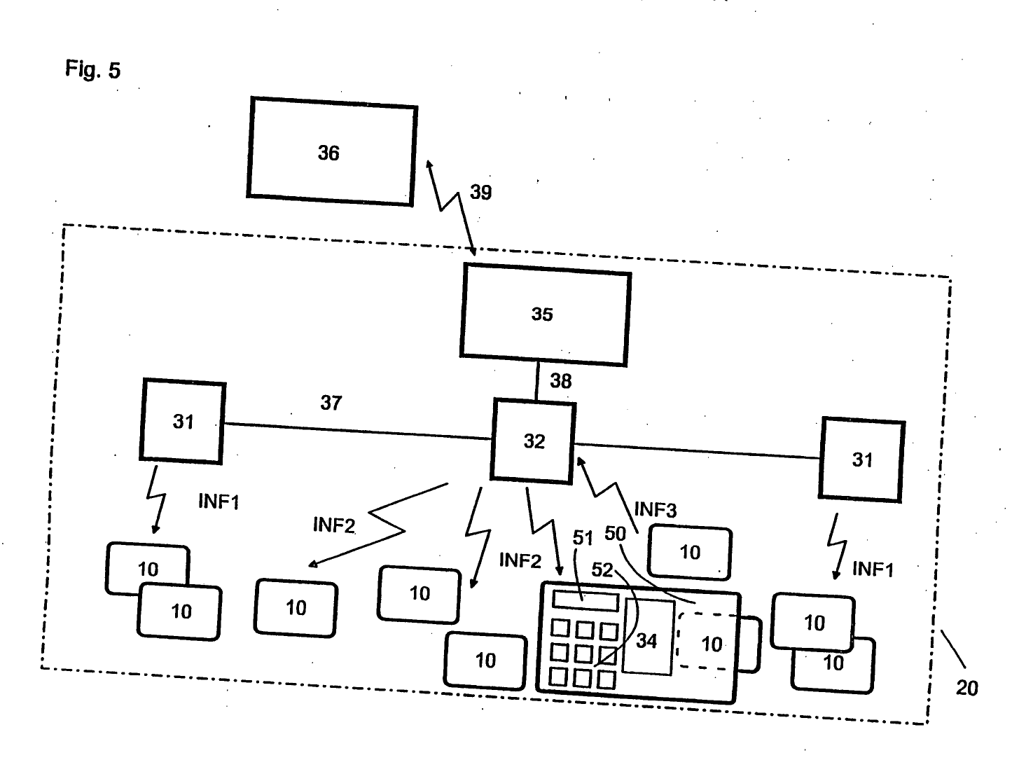

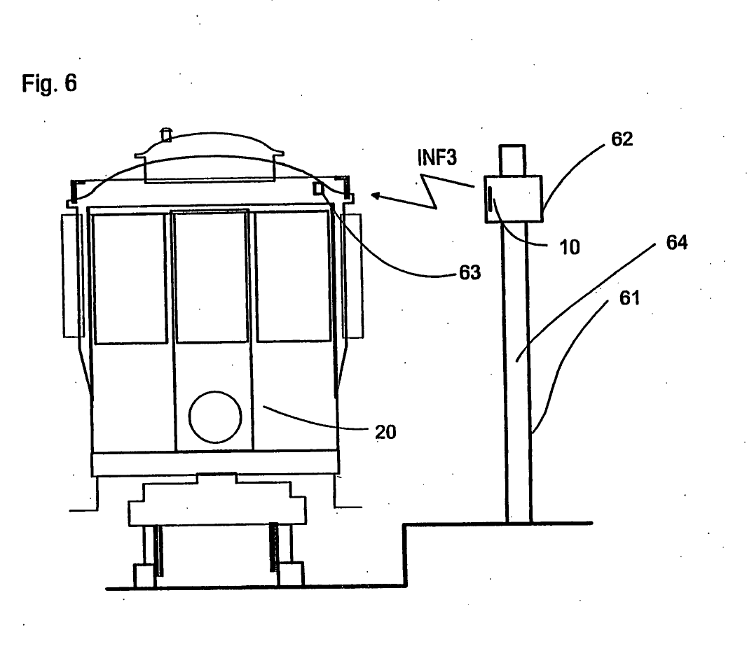

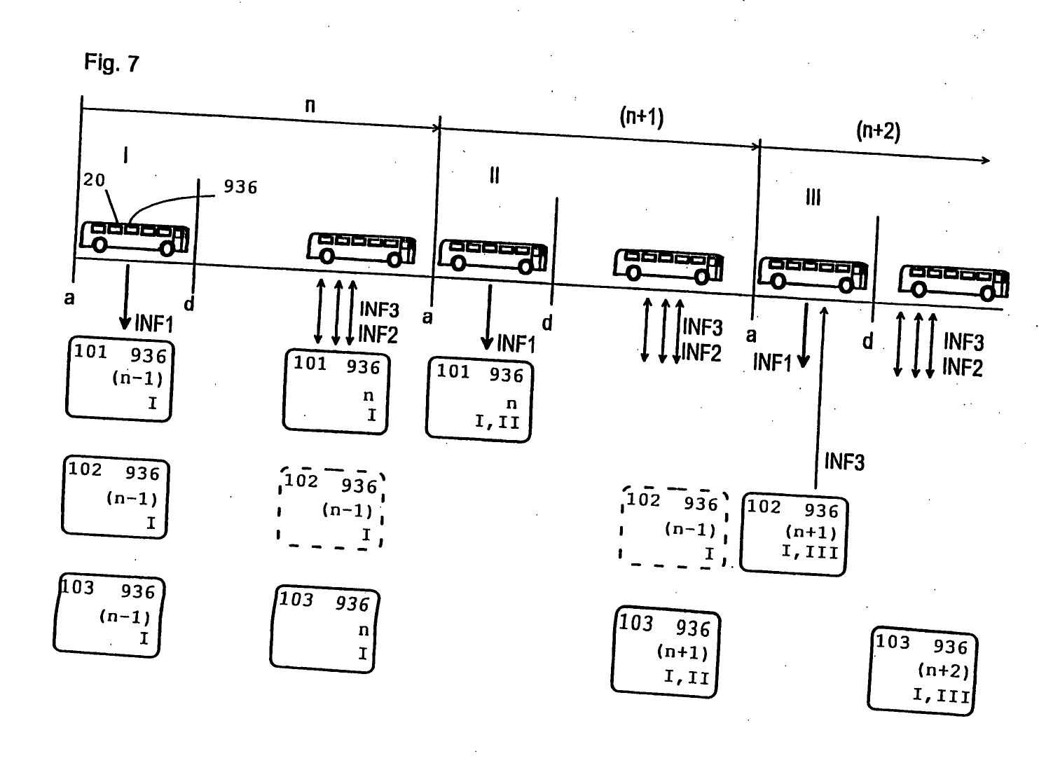

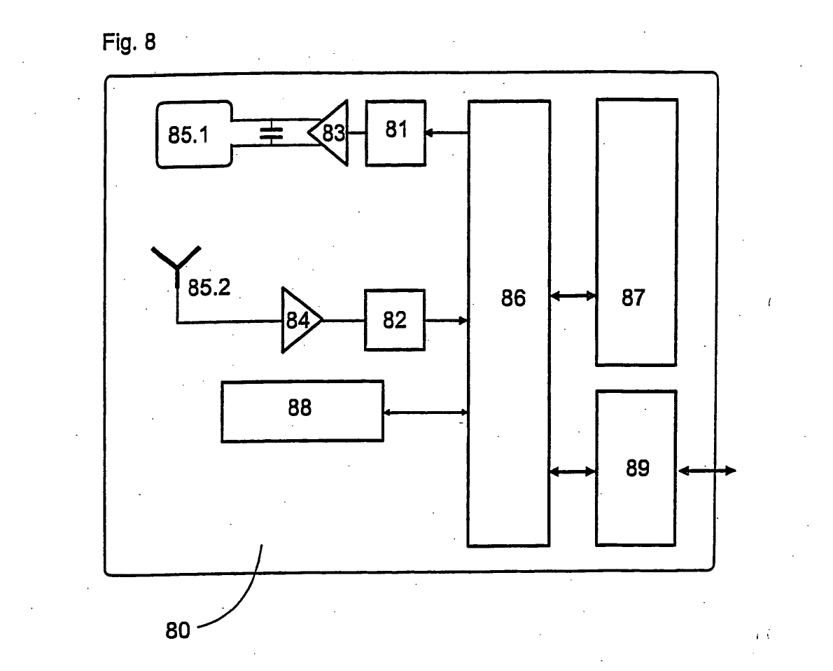

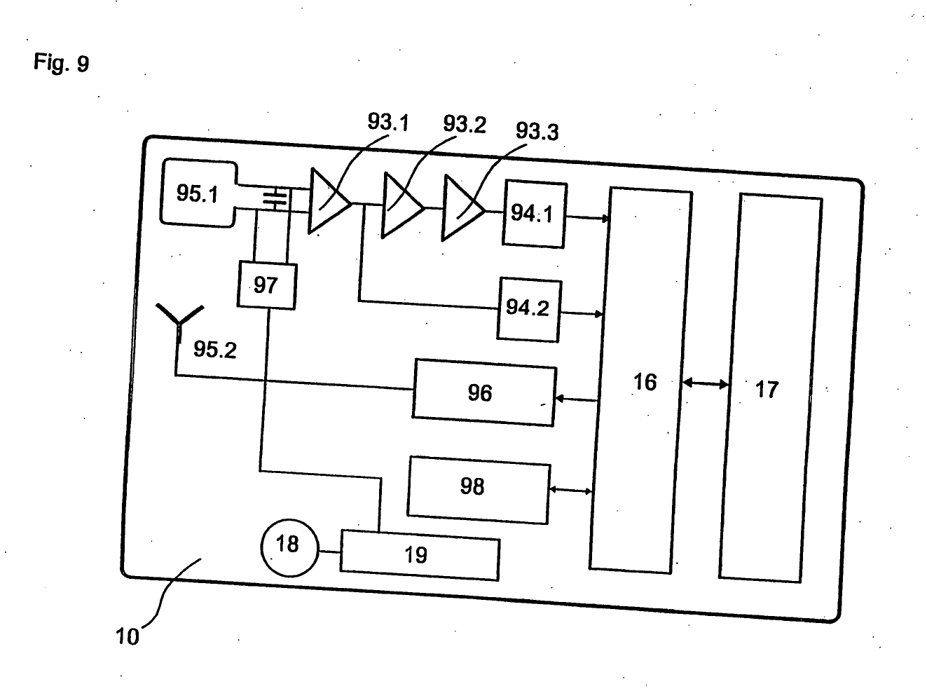

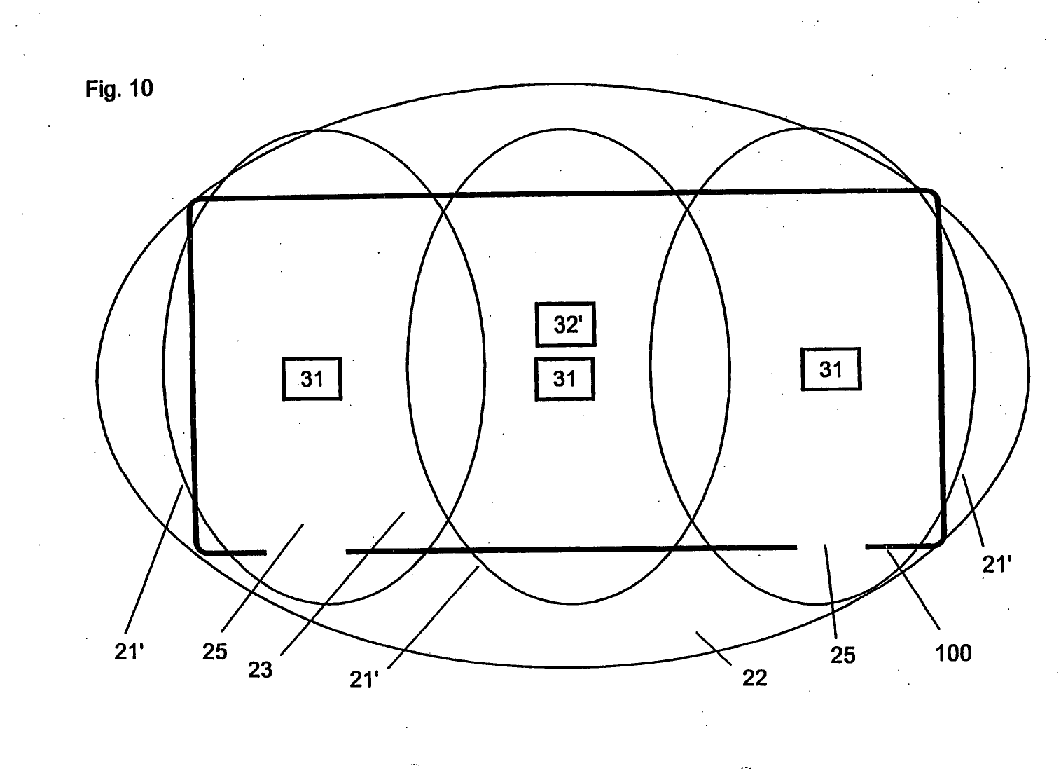

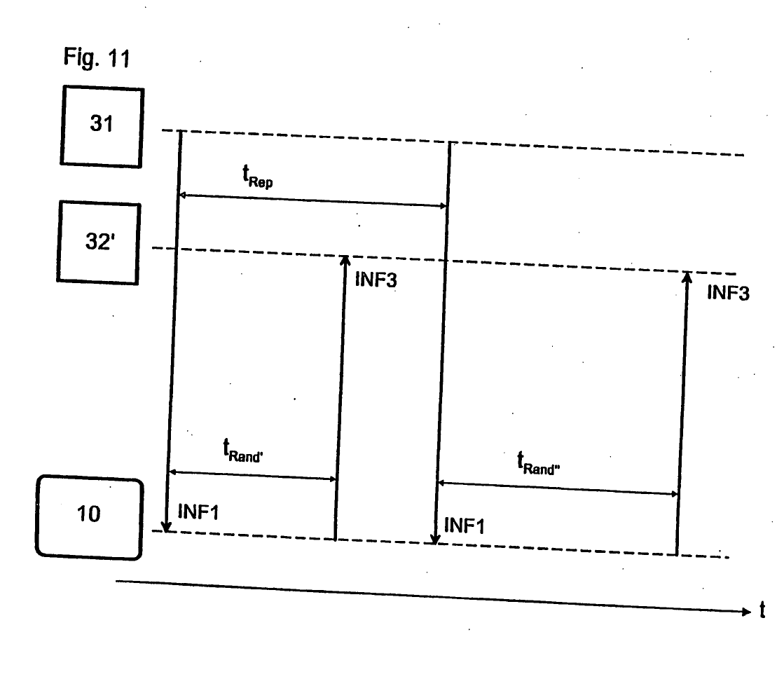

The sequence shown in FIGS. 3a and 3b must be performed for many tickets within the time available between two stops. FIG. 4 shows the timing sequence of communication for procedural step phase1 and FIG. 5 shows the sequence for procedural step phase2.

Detailed description of procedural step phase1 Experts assign the term “GET” to this phase shown in detail in FIG. 4: Information is retrieved from the tickets 10. The dashed outline CF shows a first frame CF with what are known as slot zones, numbered in the present embodiment from 1 to 512. Depending on application a period of time ranging from 4 to 10 s. can be provided for all of these 512 slot zones, producing a duration of around 8 to 20 ms for each slot. Three tickets are considered, identified in FIG. 4 as X, Y and Z. from their previous history tickets X and Y each have a slot number, identified with reference to FIG. 4 by the notation (X, 2) and (Y, 1). Ticket Z is a virgin ticket; (Z, −). The time of transmission is determined by the slot numbers already present on the ticket 10 if necessary. In accordance with the diagram shown in FIG. 4 this is done for ticket Y with unit T_{Y}, in which case this will be acknowledged by the second transceiver unit 32 with acknowledgement Q₁. The index however relates to the slot number here and not to the ticket. In the case of ticket X with the previous history (X; 2) is assumed that the transmission of the information T_{X} was not recognized by the second transceiver unit 32 because of an error or collision. This type of communication occurs for all the tickets 10 located within the tram for which the number is restricted to 512 in the present embodiment. Following on from frame CF with the 512 slot zones a further frame shown by a dashed outline ACA is provided. No fixed slots are provided within this frame ACA. With the transfer of information unit S_{G} the allocation and duration of the frame CF is also known on each ticket.

Those tickets which have not received an acknowledgement within frame CF start communication in frame ACA at a randomly determined point in time. This is shown for ticket X in FIG. 4—this ticket does not receive in frame CF with slot number 2 a second information unit Q₂ as an acknowledgement—in the information unit Q₃ transferred slot number 3 is included for ticket X, this slot number 3 replaces the previous slot number 2 and is used in future by ticket X. As a result of an information unit T_{Z} also transmitted to bat a point in time determined at random ticket Z receives as an acknowledgment an Information unit Q₁₄ which on ticket Z produces the assignment (Z, 14). This type of retrospective collection of with the second information embodied as an acknowledgment message in Shawls that for assignments of slot numbers which have not yet taken place or not yet been recognized as valid a reliable storage is thus achieved. The duration of the frame ACA preferably amounts to a multiple n of the duration of frame CF. The number in this case depends on the relevant application; it is possible to provide a dynamic value for n here which is also transmitted in the first Information unit St or if necessary S_{G}. The administration of the slot numbers is or is undertaken on the second transceiver unit 32 side. It is however sufficient to merely maintain a list of the occupancy of the slot numbers, the need for the assignment of slot number to ticket to be stored on the second transceiver unit 32 side can be of advantage in specific application cases but does not absolutely have to be undertaken. It is very possible that not all tickets 10 were registered in frame ACA. There is there for provision in a further preferred embodiment for procedural step phase1 to be iterated between two stops. No further interaction needs to be undertaken within the frame CF in this case but in the execution of frame ACA for the second time any ticket which has not yet had a slot number assigned to it registers again at randomly determined points in time. This communication allows the energy consumption on the tickets to be minimized: The tickets are woken up by the first information unit S_{G} then no either as a result of the allocated slot number when a second information unit is to be sent out or in the event of an error the point in time from which at randomly specified points in time a second information unit T can be sent out. The relevant slot is used for the receipt of a second information unit Q as an acknowledgment to the ticket involved.

As an alternative to the procedural step for the phase phase1 or referred to as GET, tickets to end a can be allocated to a contiguous sequence of slot numbers, beginning at 1, by the value 1 in each case on the transceiver unit side if a ticket with a message Q was assigned a slot. This means that a ticket which as a result of the previous history has registered with a relatively high slot number is given at a lower slot number for future communication with the message Q. The method mentioned here as well as the alternative for the phase phase1 or he procedural step referred to as GET are administered from the time point of view by decrementing by 1, in the present exemplary embodiment the first slot would have the number 512.

Detailed description of procedural step phase2 Experts assign the term “SET” to this phase shown in detail in FIG. 5: Information can be explicitly transmitted to or even set on tickets 10. The dashed outline CF again shows a frame CF with the previously mentioned slot zones, provided with slot numbers from 1 to 512. Three tickets X, y and Z are considered, given the identities and slot zone assignments of (X, 3), ((y, 1) and (Z, 4). A first information unit S_{S} is sent out by the first transmitter unit 31. As a result of the preceding procedural step or steps phase1 each ticket contains the information as to the slot—identified by the slot number—in which a message for the ticket concerned is coming. With the receipt of the first information unit S_{S} the tickets are “woken up” and can “go back to sleep” until the relevant ticket-individual slot; this makes significant energy savings possible. An “addressed” transfer takes place in the slots in involved by the second transceiver unit 32 of second information units U, in the example in accordance with FIG. 5 these are, in the order of the slot zones, the information units U_{Y}, U_{X} and U_{Z}. The receipt of an information unit U is a acknowledged by the ticket concerned with a second information unit Q. In the case of the assignment (Z, 4) it is assumed that the second information unit the U_{Z} could not be received by the ticket Z. This is established on the second transceiver unit side 32 by the fact that a corresponding second information unit Q does not arrive. A repetition of the sequence of the frame CF can also be provided for the procedural step phase2; the first repetition is designated by rep in FIG. 5. The definition of number of packet retries is applicable for the relevant registration zone 22 and is also contained in the first information unit S_{S}. In accordance with the diagram shown in FIG. 5 there is a further transmission of a second information unit U_{Z} in the slot with the number 4 which is then acknowledged by the relevant ticket Z with a second information unit Q. In the further packet retries of frame CF there is only transmission in those slots to which a ticket was previously assigned and by which no second information unit Q could yet be received from the procedural step phase2.

The information units listed here St, S_{G}, S_{S}, T and Q have the structure detailed below in Tables 1 and 2 in a preferred embodiment of the present invention. The tables only show the fields necessary to execute the present invention. Structure of information units S_{G}, S_{S}, T and Q

TABLE 1

| Information field | Meaning |
|---|---|
| . | |
| . | |
| . | |
| RECEIVE-ID | Address of the receiver; including the |
| | entry OXFFFFFFFFH for broadcast for |
| | example |
| SENDER-ID | Address of the transmitter; symmetrical |
| | representation to RECEIVE-ID |
| CON TIN_NR | Continuous number range of values 0 . . . |
| | OxFFH |
| LEN | Length of the information unit from this |
| | field on |
| KEY | Key; Values: MULTI; SINGLE; QUITT; NO- |
| | ACKN; . . . |
| PAYLOAD | Payload information, if the KEY field |
| | contains a value of MULTI a subregister is |
| | contained in the PAYLOAD field, otherwise |
| | the payload information is contained |
| | directly in this field. |

This structure. with the value KEY<>MULTI is provided in particular for the information units S_{G}, S_{S}, T and Q. The value MULTI can be provided in the field KEY for information units T and U, so that a further register can be contained in the field PAYLOAD. This structure of subregister PAYLOAD is for the above-mentioned case in which the agreed value MULTI is in the information field, shown in Table 2 below as typically representing two subinformation units. Instead of the term information unit the expert also uses the terms record and telegram, depending on the viewpoint, namely from the point of view of information or the point of view of telecommunication. Accordingly these information units with a specific but variably-embodied structure are also designated as container telegrams The contents of the RECEIVE-ID field describes the address of the recipient. It is assumed here that the address space is dimensioned with 4 bytes corresponding to 2³². Specific values can be provided here in hexadecimal such as OxFFFFFFFF or OXFFFFOO for specific broadcast messages. Symbolic values are not specified definitely in the field KEY in Table 1, these can for example be combined in a representation of one byte by a logical OR operation. The specified values stand for
MULTI: The field PAYLOAD contains at least one subregister;
SINGLE: The field PAYLOAD is single;
QUITT: The information unit is an acknowledgement;
NO-ACKN: The recipient does not need to confirm (acknowledge) the receipt of the transferred information unit.

Some of the content listed below can also be contained in other fields—also called flags—and the embedding in a structure in accordance with Table 2 only represents an example of an implementation of the present invention.

Structure of the PAYLOAD Register

TABLE 2

| Information field | Meaning |
|---|---|
| SUB-LENGTH1 | |
| SUB-KEY1 | |
| SUB-PAYLOAD | |
| SUB-LENGTH2 | |
| SUB-KEY2 | |
| SUB-PAYLOAD2 | |

The LEN field of the information unit specifies the length in bytes as from this field. The structure of the PAYLOAD register in its turn has lengths for what are known as subkeys and subinformation units so that it provides an additional option for checking the plausibility of the information units transmitted. In addition the fact that the method in accordance with the invention is employed here means that for transmission on the data link layer correct transmission is checked and that if necessary a further encryption is undertaken in a layer above this, since with the transmitted information billing may also be undertaken.

The structure of the previously mentioned information unit for acknowledgement is identical insofar as the values SINGLE or QUITT are contained in the field KEY which, together with a specific specification in the LEN field also indicate a set, i.e. fixed structure in the PAYLOAD field.

Communication from a transceiver unit 32 to the tickets 10 must be iterated for receive-related reasons. So that unnecessarily processing steps of processor module 16 do not have to be executed on the tickets 10 a field CONT_NR contains a continuous number which is modified by one step each time new information, e.g. a new route or tariff section is to be transferred.

The nesting of registers technology described here is referred to by the term container telegrams. The various subregisters are especially advantageous if only one specific item of information that, such as for example the next stop or the likely arrival time at the destination is to be transferred by sending out an information unit. in such a application what is known as a broadcast address is entered into the field RECEIVE-ID and in the KEY field is the indication that the telegram received is not to be it knowledge by a ticket, for example with NOACKN”. Depending on the application, various types of broadcast can also be provided, in which specific sections of the address space, e.g. the addresses 0x00000000 . . . 0x0000FFFF (specified in hexadecimal notation) have a fixed specific meaning. If specific addresses are provided in the RECEIVE_ID field for broadcasts, it is advantageous to provide these identically both in the first information unit Ss and also in the second information unit U. In this case there can be provision on the tickets for all tickets to be activated in a specific slot—and subsequently go back to sleep again—, so that the radio medium is occupied as little as possible. The iteration of the frame CF in the phase phase2 needs to be performed in particular if specific information is to be written explicitly onto the ticket located in registration zone 22. The requirement is therefore to occupy the radio medium as little as possible, since for the case of a tram or for busses in the area or a large stops overlapping of the various registration zones will necessarily occur and this will provoke collisions in communication. The mechanisms previously mentioned such as acknowledgement on the basis of a CRC or the structure of the information units transferred with the fields SENDER_ID and RECEIVE_ID exclude incorrect registration, temporary non-registration remains possible.

Depending on the requirements of a concrete application, the three-phase method in accordance with invention with the phases marq, phase1 and phase2 together with the flexible structure of the first and/or second information units transferred, can be adapted to further applications and is therefore not at all restricted to the embodiment described here.

With interaction through a person obtaining a service can be deliberately “legalized” in a further embodiment of the present invention or a service is obtained with the explicit understanding of the person using the ticket 10. This can either be undertaken with an actuation element on the ticket 10 or by a device which is in electrical or just in radio contact with the ticket 10. For what is referred to as radio contact the further transceiver modules 13 and 14 are provided on the ticket 10 which are based for example on the vicinity or proximity card principle. This ensures that on the bearer or the person to whom such a ticket is assigned has previously professed their intention to obtain a service.

The present invention can also be applied to tracing objects, for example the tracing of strong boxes within an airport site. So-called “combi tickets” also allow the present invention it to be applied to multi-storey car parks. With one and the same electronic ticket 10 registration it can be undertaken both in a public transport system with a registration on the “Be-in/Be-out” principle without the explicit declaration of understanding of the bearer as well as for registration on the principle of an explicit declaration of understanding.

1. A method of registering tickets for establishing a service to be obtained and/or a defined presence within a registration zone, where the tickets feature a processor module, a memory module and at least a first receive module and a second transceiver module and in the registration zone at least a first transmitter unit sending out information units and for bidirectional communication with the tickets by means of second information units transferred a second transceiver unit are assigned; in which case the sending out of first information units at least switches the tickets located in the registration zone intermittently to active; characterized by the procedural steps,
marq: the first information unit contains the identity of the registration zone or of the assigned transmitter units and transceiver units in the registration zones and on being received by a ticket are stored on the latter;
phase: with a further first information unit received by a ticket bidirectional communication is initiated by second information units if the identities transferred in procedural step marq: and phase match, in which case in the second information units a field is provided that describes the structure of the second information unit.

2. The method in accordance with claim 1, characterized in that the frequency of the first transmitter unit is selected so that the field within the registration zone is embodied as a near field.

3. The method in accordance with claim 1, characterized in that the frequency of the second transceiver unit and of the second transceiver module are selected so that the electromagnetic field in the registration zone is embodied as a far field.

4. The method in accordance with one of the claim 1, characterized in that the procedural step phase: is iterated.

5. The method in accordance with one of the claim 1, characterized in that the procedural step phase: is subdivided into the steps phase1: and phase2:.

6. The method in accordance with one of the claim 1, characterized in that the correct receipt of a second information unit sent out is acknowledged with a second Information unit sent in the opposite direction as an acknowledgment message.

7. The method in accordance with claim 5, characterized in that in procedural step phase1: a first frame with a fixed division into slots and a second frame are provided and that an assignment to a slot with a slot number can be stored on each ticket.

8. The method in accordance with claim 7, characterized in that those tickets on which a slot number is stored send out a second information unit in the slot concerned and the other tickets send out a second information unit at a randomly determined point in time within the second frame, in which case a slot number is contained in the acknowledgement and is stored if the assignment does not take place or is not recognized as valid.

9. The method in accordance with claim 8, characterized in that the tickets are switched to active during the sending out of a second information unit and of an interval after this.

10. The method in accordance with claim 8, characterized in that the procedural step phase1: is iterated and that the duration of the second frame ACA amounts to a multiple of the duration of the first frame.

11. The method in accordance with one of the claim 8; characterized in that the procedural step phase2: is undertaken in a frame with a fixed division into slots and after receipt of the further first information unit each ticket in the slot concerned is switched to active in order to be able to receive a second information unit sent out by the second transceiver unit.

12. The method in accordance with claim 11, characterized in that in procedural step phase2: the frame is provided repetitively.

13. The method in accordance with claim 12, characterized in that in procedural step phase2: in the frame following the first frame second information units are only sent out in those slots by the second transceiver unit in which no acknowledgment message was previously received from the ticket concerned.

14. The method in accordance with one of the claim 6; characterized in that an acknowledgment message is sent out if no error has been established in the data link layer as a result of a check.

15. The method in accordance with one of the claims 1; characterized in that in the first and/or second information units determined at least one information field contains information as to whether the information unit involved has a variable structure.

16. The method in accordance with claim 1; characterized in that in the first and/or second information units transferred to the ticket information is contained in at least one information field that the information unit involved is directed to only one ticket or to a plurality of tickets.

17. The method in accordance with claim 1, characterized in that the first and/or second information units transferred to the tickets contain a continuous number in at least one information field which then undergoes a change if the payload content of an information unit previously sent out has undergone a change.
